(19) United States
(12) Patent Application Publication
(10) Pub. No.: US 2025/0218622 A1
(43) Pub. Date: Jul. 3, 2025

(54) HEAT DISSIPATION STRUCTURE AND COOLING METHOD

(71) Applicant: INDUSTRIAL TECHNOLOGY RESEARCH INSTITUTE, Hsinchu (TW)

(72) Inventors: Yung-Jen CHENG, Hsinchu City (TW); Ya-Chi HO, New Taipei City (TW); Tsai-Liang WU, Hsinchu City (TW); En-Lan HU, Hsinchu City (TW); Po-Chih CHEN, New Taipei City (TW)

(73) Assignee: INDUSTRIAL TECHNOLOGY RESEARCH INSTITUTE, Hsinchu (TW)

(21) Appl. No.: 18/596,436

(22) Filed: Mar. 5, 2024

(30) Foreign Application Priority Data
Jan. 3, 2024 (TW) 113100238

(51) Int. Cl. H01B 7/42; B60L 53/18; B60L 53/302; F28F 13/12; F28F 21/08

(52) U.S. Cl. CPC H01B 7/423; B60L 53/18; B60L 53/302; F28F 13/125; F28F 21/081

(57) ABSTRACT

A heat dissipation structure configured to cool a cable, includes a cable jacket, an electric conductor, and a deformable component which is temperature-adaptive and in a helical shape. The cable jacket has a fluid channel extending along an axial direction of the cable jacket. The electric conductor is disposed in the cable jacket. The deformable component is disposed in the fluid channel. The deformable component allows a two-phase flow and a vortex to be generated in a working fluid in the fluid channel.

### CROSS-REFERENCE TO RELATED APPLICATIONS

All related applications are incorporated by reference. The present application is based on, and claims priority from, Taiwan (International) application No. 113100238 filed on Jan. 3, 2024, the disclosure of which is hereby incorporated by reference herein in its entirety.

### TECHNICAL FIELD

The disclosure relates to a heat dissipation structure and a cooling method configured to cool a cable.

### BACKGROUND

Based on the concept or appeal of environmental protection, the efficiency of power supply for large electronic apparatus draws significant attention. Taking land vehicles as an example, electric vehicles have become one of the key industries that draws the attention of the market. Currently, electric vehicles are mainly powered by rechargeable batteries. When the rechargeable battery runs out of power, the rechargeable battery is replaced or charged.

To improve the charging rate of electric vehicles, realizing fast charging by a charging station that provides cables with a high current of 2000 ampere or more is a growing trend. However, due to safety considerations, the specification of the temperature of cable during charging is defined in countries around the world. For example, relevant specification in Japan and European Union demands that the temperature in any region of the cable to be 40° C. or less during charging. Therefore, this field currently needs a solution that can realize high charging rate while effectively cooling the cable.

### SUMMARY

It should be noted that the disclosure can be widely used in electric vehicles and is not limited to the electric land vehicle.

An embodiment of the disclosure discloses a heat dissipation structure configured to cool a cable including a cable jacket, an electrical conductor and a deformable component, being temperature-adaptive and in a helical shape. The cable jacket has a fluid channel extending along an axial direction of the cable jacket. The electrical conductor is disposed in the cable jacket. The deformable component is disposed in the fluid channel. The deformable component allows a two-phase flow and a vortex to be generated in a working fluid in the fluid channel.

An embodiment of the disclosure discloses a cooling method which includes providing a working fluid into a fluid channel of a cable jacket and allowing a two-phase flow and a vortex to be generated in the working fluid by a deformable component disposed in the fluid channel, wherein the deformable component is temperature-adaptive and in a helical shape.

The above description of the content of the disclosure and the following detailed description are configured to demonstrate and explain the principle of the disclosure and provide further explanation for the claims of the disclosure.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a schematic diagram of charging an electric vehicle by using a charging station;

FIG. 2 is a schematic diagram of a heat dissipation structure according to one embodiment of the disclosure;

FIG. 3 is a schematic diagram of a deformable component in FIG. 2;

FIG. 4 is a front view of the deformable component in FIG. 3;

FIG. 5 is a schematic diagram of the heat dissipation structure in FIG. 2 at low temperature;

FIG. 6 is a schematic diagram of the heat dissipation structure in FIG. 2 at high temperature; and

FIG. 7 is a schematic diagram showing a measurement of the temperature on the outer surface of the heat dissipation structure.

### DETAILED DESCRIPTION

The detailed features and advantages of the disclosure are described in detail in the following detailed description, the content is sufficient to understand the technical content of the disclosure and implement accordingly for those skilled in the art. According to the content, claims and drawings disclosed in this specification, those skilled in the art can easily understand the relevant purposes and advantages of the disclosure. The following embodiments further describe the perspective of the disclosure in detailed, but do not limit the scope of the disclosure in any perspective.

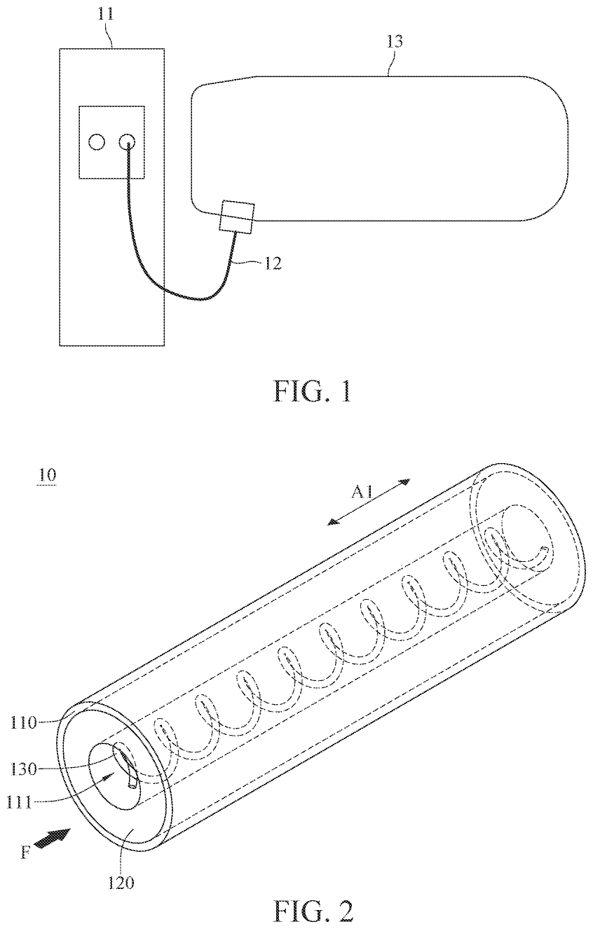

Please refer to FIG. 1 that is a schematic diagram of charging an electric vehicle 13 by using a charging station 11. The charging station 11 is equipped with a cable 12 and can charge the electric vehicle 13 through the cable 12. Due to the safety considerations, the temperature of the cable 12 during charging needs to be limited. Further, the temperature on an outer surface of the cable 12 needs to be limited. It should be noted that the disclosure can be widely used in electric vehicles and is not limited to the electric land vehicle.

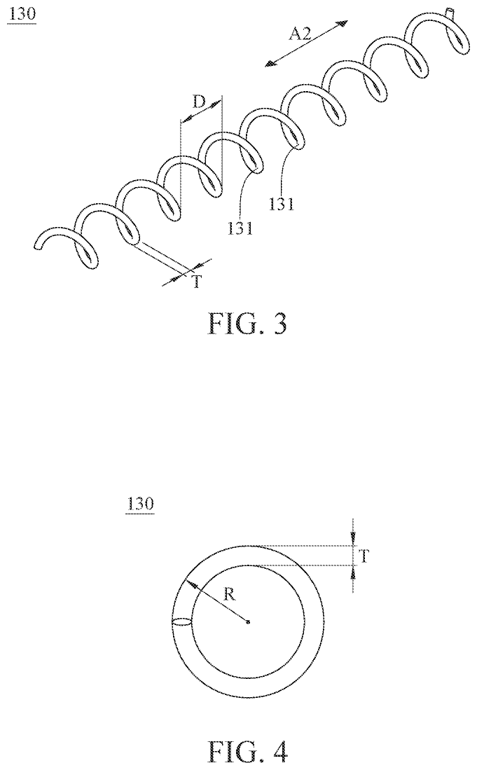

The disclosure provides a heat dissipation structure 10 that can be applied to the cable 12 in FIG. 1. Please refer to FIG. 2 to FIG. 4, where FIG. 2 is a schematic diagram of the heat dissipation structure 10 according to an embodiment of the disclosure, FIG. 3 is a schematic diagram of a deformable component 130 in FIG. 2, and FIG. 4 is a front view of the deformable component 130 in FIG. 3. In this embodiment, the heat dissipation structure 10 is configured to cool the cable 12, and includes a cable jacket 110, an electric conductor 120, and a deformable component 130.

The electric conductor 120 is disposed on the cable jacket 110. Further, the cable jacket 110 is made of an electrically insulating material, the outer surface of the cable jacket 110 can be understood as the outer surface of the cable 12 shown in FIG. 1. The electric conductor 120 is disposed in the cable jacket 110. The cable jacket 110 and the electric conductor 120 may be coaxially disposed.

The cable jacket 110 has a fluid channel 111 which extends along an axial direction A1 of the cable jacket 110. The fluid channel 111 may allow a working fluid F to flow therethrough. The working fluid F is, but not limited to, water, methanol, acetone, electronic fluoride fluid, mineral oil, or a fluid including nanoparticles. The working fluid F is configured to cool the cable jacket 110. In this embodiment, the electric conductor 120 is disposed in the cable jacket 110 and in fluid communication with the fluid channel 111, which allows the working fluid F to be in direct contact with the electric conductor 120. Thus, the working fluid F must be non-conductive. For example, the working fluid F may be Milli-Q water containing nano silicon particles.

The heat dissipation structure 10 illustrated in FIG. 1 is an example. In some other embodiments, the heat dissipation structure may further include an insulating layer accommodated within the cable jacket. The electric conductor is covered by the insulating layer, and the fluid channel is formed by the insulating layer. In still some other embodiments, the heat dissipation structure may further include a waterproof jacket accommodated within the cable jacket. The electric conductor is disposed between the waterproof jacket and the cable jacket, and the fluid channel is formed by the waterproof jacket.

The deformable component 130 is disposed in the fluid channel 111. Further, an axial direction A2 of the deformable component 130 is substantially parallel to the axial direction A1 of the cable jacket 110. Further, the deformable component 130 and the cable jacket 110 are coaxially disposed. The deformable component 130 may include a shape-memory alloy. For example, the shape-memory alloy may be selected from a group consisting of nickel-titanium alloy, manganese-silicon-iron alloy, zinc-copper-aluminum alloy, nickel-copper-aluminum alloy, nickel-titanium-iron alloy, and nickel-titanium-copper alloy.

In this embodiment, the deformable component 130 is in a helical shape. Further, the deformable component 130 includes a plurality of turns connected to one another, and these turns are arranged along the axial direction A1 or A2. As shown in FIG. 3, the wire diameter T of each turn 131 can range from 0.10 millimeter (mm) to 8.0 mm. In some other embodiments, the wire diameter T may range from 0.10 mm to 5.0 mm. In still some other embodiments, the wire diameter T may range from 0.10 mm to 2.50 mm.

As shown in FIG. 4, in this embodiment, the radial size R of each turn 131 can range from 1.0 mm to 20.0 mm. In some other embodiments, the radial size R can range from 1.0 mm to 10.0 mm.

As shown in FIG. 3 and FIG. 4, in this embodiment, the axial distance D between two adjacent turns can range from 0.50 mm to 20.0 mm. In some other embodiments, the axial distance D can range from 0.50 mm to 15.0 mm. In still some other embodiments, the axial distance D can range from 0.50 mm to 10.0 mm.

In this embodiment, by the plurality of turns 131 included in the deformable component 130 disposed in the fluid channel 111, a vortex is allowed to be generated in the working fluid F to achieve the cooling purpose. Regarding to the size of each turn 131 of the deformable component 130, the wire diameter T, the axial size R, and the axial distance D between two adjacent turns 131 may be individually designed according to actual requirements. Generally, if the wire diameter T is larger than 8.0 mm, the flow resistance will be increased and the flow of the working fluid F will be disturbed, thereby decreasing the heat transfer efficiency. If the wire diameter T is smaller than 0.10 mm, the vortex will be hard to be generated.

For the shape-memory alloy included in the deformable component 130, if the shape-memory alloy includes titanium, the percentage of titanium in the shape-memory alloy may be 5.0% to 95.0%.

For the shape-memory alloy included in the deformable component 130, if the shape-memory alloy includes nickel, the percentage of nickel in the shape-memory alloy may be 10.0% to 90.0%.

For the shape-memory alloy included in the deformable component 130, if the shape-memory alloy includes iron, the percentage of iron in the shape-memory alloy may be 5.0% to 90.0%.

For the shape-memory alloy included in the deformable component 130, if the shape-memory alloy includes manganese, the percentage of manganese in the shape-memory alloy may be 5.0% to 85.0%.

For the shape-memory alloy included in the deformable component 130, if the shape-memory alloy includes silicon, the percentage of silicon in the shape-memory alloy may be 5.0% to 85.0%.

For the shape-memory alloy included in the deformable component 130, if the shape-memory alloy includes copper, the percentage of copper in the shape-memory alloy may be 10.0% to 70.0%.

For the shape-memory alloy included in the deformable component 130, if the shape-memory alloy includes aluminum, the percentage of aluminum in the shape-memory alloy may be 10.0% to 50.0%.

For the shape-memory alloy included in the deformable component 130, if the shape-memory alloy includes zinc, the percentage of zinc in the shape-memory alloy may be 5.0% to 50.0%.

According to one or more embodiments, deformable component 130 may include any one of the following shape-memory alloy A to shape-memory alloy Q.

| | Alloy type | Composition |
|---|---|---|
| Shape-memory | Nickel-titanium alloy | Nickel 20.0%, titanium |
| alloy A | | 80.0% |
| Shape-memory | Nickel-titanium alloy | Nickel 35.0%, titanium |
| alloy B | | 65.0% |
| Shape-memory | Nickel-titanium alloy | Nickel 10.0%, titanium |
| alloy C | | 90.0% |
| Shape-memory | Nickel-titanium-copper | Nickel 20.0%, titanium |
| alloy D | alloy | 40.0%, copper 40.0% |
| Shape-memory | Nickel-titanium-copper | Nickel 35.0%, titanium |
| alloy E | alloy | 30.0%, copper 30.0% |
| Shape-memory | Nickel-titanium-copper | Nickel 20.0%, titanium |
| alloy F | alloy | 20.0%, copper 60.0% |
| Shape-memory | Nickel-titanium-copper | Nickel 85.0%, titanium |
| alloy G | alloy | 5.0%, copper 10.0% |
| Shape-memory | Manganese-silicon-iron | Iron 20.0%, manganese |
| alloy H | alloy | 40.0%, silicon 40.0% |
| Shape-memory | Manganese-silicon-iron | Iron 60.0%, manganese |
| alloy I | alloy | 20.0%, silicon 20.0% |
| Shape-memory | Manganese-silicon-iron | Iron 20.0%, manganese |
| alloy J | alloy | 60.0%, silicon 20.0% |
| Shape-memory | Manganese-silicon-iron | Iron 10.0%, manganese |
| alloy K | alloy | 80.0%, silicon 10.0% |
| Shape-memory | Zinc-copper-aluminum | Copper 25.0, zinc 35.0%, |
| alloy L | alloy | aluminum 40.0% |
| Shape-memory | Zinc-copper-aluminum | Copper 40.0%, zinc 10.0%, |
| alloy M | alloy | aluminum 50.0% |
| Shape-memory | Nickel-copper-aluminum | Copper 30.0%, aluminum |
| alloy N | alloy | 40.0%, nickel 30.0% |
| Shape-memory | Nickel-copper-aluminum | Copper 60.0%, aluminum |
| alloy O | alloy | 10.0%, nickel 30.0% |
| Shape-memory | Nickel-titanium-iron | Nickel 30.0%, titanium |
| alloy P | alloy | 50.0%, iron 20.0% |
| Shape-memory | Nickel-titanium-iron | Nickel 30.0%, titanium |
| alloy Q | alloy | 30.0%, iron 40.0% |

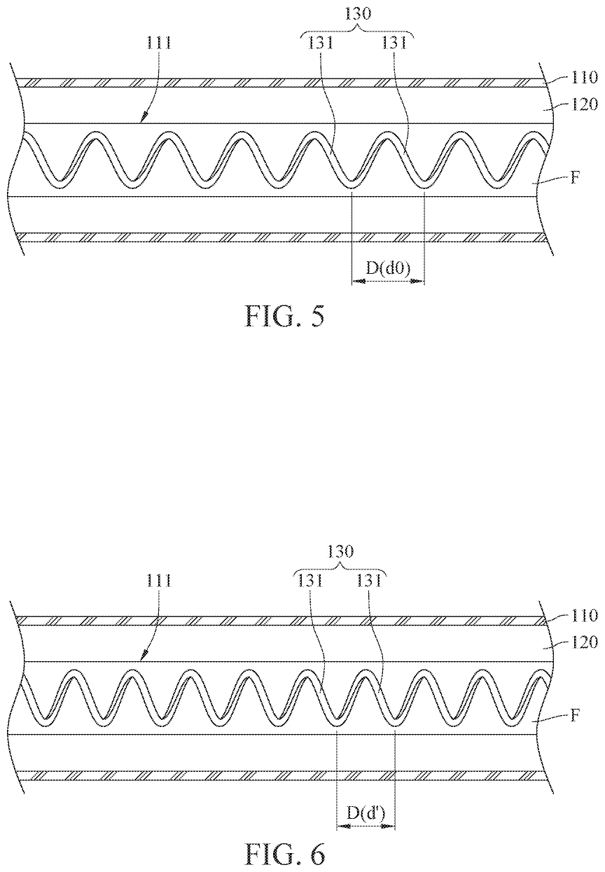

The deformable component 130 allows the two-phase flow and the vortex to be generated in the working fluid F in the fluid channel 111, thereby achieving the cooling purpose. Please refer to FIG. 5 and FIG. 6, where FIG. 5 is a schematic diagram of the heat dissipation structure 10 in FIG. 2 at a first temperature, and FIG. 6 is a schematic diagram of the heat dissipation structure 10 in FIG. 2 at a second temperature. In this embodiment, the second temperature is higher than the first temperature. The first temperature is in, but not limited to, a range from 5.0° C. to 45.0° C., the second temperature is, but not limited to, higher than 45.0° C.

In this embodiment, the deformable component 130 is temperature-adaptive.

Further, the deformable component 130 can extend and contract along the axial direction A2 based on the temperature variation, thereby changing the axial distance D between two turns 131. As shown in FIG. 5, when the working fluid F is at the first temperature (relatively low temperature), the axial distance of the deformable component 130 may have an original value d0, which can be understood as D=d0. As shown in FIG. 6, when the temperature of the working fluid F increases to the second temperature (relatively high temperature), the deformable component 130 contracts along the axial direction A2 in response to the increase of the temperature, thereby decreasing the axial distance between two turns 131 to a value d′, which can be understood as D=d′ and d′<d0. Similarly, when the temperature of the working fluid F decreases, the deformable component 130 extends along the axial direction A2 in response to the decrease of the temperature, thereby increasing the axial distance D between two turns 131.

The surface of the deformable component 130 helps the liquid working fluid F to transition from liquid to vapor, thereby forming the two-phase flow. In other words, the deformable component 130 decreases the boiling point of the working fluid F, and allows the working fluid F to vaporize at a relatively lower temperature, thereby achieving the cooling purpose by the heat absorption during the vaporization. More specifically, when the temperature of the working fluid F increases, the deformable component 130 contracts along the axial direction A2 and allows the arrangement density of these turns 131 to be increased, and thus more parts of the deformable component 130 can be accommodated within per unit length of the cable jacket 110. In addition, the extra additives like nanoparticles in the working fluid F also decrease the boiling point of the working fluid F. In this embodiment, the deformable component 130 allows the two-phase flow to be generated in the working fluid F in a temperature ranging from 40° C. to 90° C., so that the deformable component 130 is more compatible with the application of the heat dissipation for the charging cable for the electric vehicle, but the disclosure is not limited thereto.

The turns 131 of the deformable component 130 facilitate the vortex to be generated in the working fluid F. Further, the deformable component 130 has an adaptive deformation characteristic so that the vortex is generated in the working fluid F by changing the axial distance D of two turns 131. More specifically, when the temperature of the working fluid F increases, the deformable component 130 contracts along the axial direction A2 and allows the arrangement density of these turns 131 to be increased, and thus more parts of the deformable component 130 can be accommodated within per unit length of the cable jacket 110. Accommodating more parts of the deformable component 130 allows the vortex with higher strength to be generated in the working fluid F. In this embodiment, the deformable component 130 has the adaptive deformation characteristic that allows the axial distance D to vary in a range from 0.50 to 20.0 mm.

According to one or more embodiments, the adaptive deformation characteristic of the deformable component 130 allows it to contract as the temperature increases, and thus facilitates the vortex to be generated. If the deformable component 130 extends as the temperature increases, (i.e., the increase in temperature increases the axial distance D) the effect of facilitating the generation of the vortex will be limited. Accordingly, the material selection of the deformable component 130 is noteworthy.

In summary, the two-phase flow and the vortex are generated in the working fluid F by the deformable component 130 disposed in the fluid channel 111. The surface of the deformable component 130 decreases the boiling point of the working fluid F, and allows the two-phase flow to be formed more easily in the working fluid F, thereby achieving the cooling purpose by the heat absorption during the vaporization. The deformable component 130 in a helical shape allows the vortex to be generated in the working fluid F to achieve the cooling purpose by including a plurality of turns 131. The temperature-adaptive characteristic of the deformable component 130 can facilitate the formation of the two-phase flow and increase the strength of the vortex as the temperature of the working fluid F is increased, thereby allowing the cooling efficiency of the working fluid to be dynamically increased as the temperature is increased.

The following provides experimental data to support the effect of improving the cooling efficiency and achieving a uniform cooling performance achieved by the deformable component 130 disclosed in the disclosure.

### EMBODIMENT

The embodiment provides the heat dissipation structure 10 shown in FIG. 2 to FIG. 4 where the axial distance of two adjacent turns 131 in the deformable component 130 may vary in a range from 0.50 mm to 20.0 mm due to the temperature variation.

### Comparative Example 1

Comparative example 1 provides a heat dissipation structure including the cable jacket 110 and the electric conductor 120 shown in FIG. 2 but excluding the deformable component.

### Comparative Example 2

Comparative example 2 provides a heat dissipation structure including the cable jacket 110 and the electric conductor 120 shown in FIG. 2, and including a helical metal spring disposed in the fluid channel 111, where the axial distance between two adjacent turns in metal spring can constantly be 30.0 mm.

### Comparative Example 3

Comparative example 3 provides a heat dissipation structure including the cable jacket 110 and the electric conductor 120 shown in FIG. 2, and including a helical metal spring disposed in the fluid channel 111, where the axial distance between two adjacent turns in metal spring can constantly be 40.0 mm.

The main differences between the heat dissipation structure in the embodiment and comparative example 1 to comparative example 3 are summarized in Table 1 below.

TABLE 1

| | | The axial distance between |
|---|---|---|
| — | Heat dissipation structure | two adjacent turns (mm) |
| Embodiment 1 | Deformable component | 0.50~20.0 |
| | (Shape-memory alloy) | |
| Comparative | None | — |
| example 1 | | |
| Comparative | Metal spring | 30.0 |
| example 2 | (Not shape-memory alloy) | |
| Comparative | Metal spring | 40.0 |
| example 3 | (Not shape-memory alloy) | |

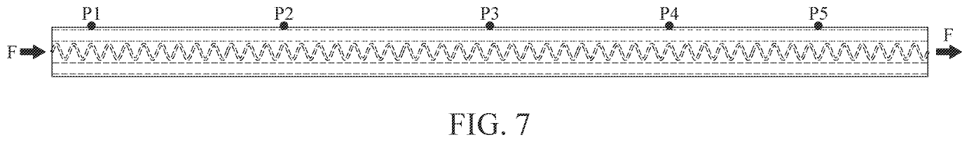

FIG. 7 is a schematic diagram showing a measurement of the temperature on the outer surface of the heat dissipation structure 10. Further, the same working fluid (e.g., Milli-Q water containing nano silicon particles) is provided in the heat dissipation structures in the embodiment and the comparative example 1 to comparative example 3. A plurality of measurement points is taken on the outer surface of the heat dissipation structure (i.e., the outer surface of the cable jacket), and the temperature at each measurement point is measured by any known means. For example, FIG. 7 shows that the measurement points P1 to P5 are taken and the temperatures at the measurement points P1 to P5 are measured. The measurement result is shown in Table 2 below.

TABLE 2
The working fluid: Milli-Q water containing nano silicon particles

| | Average | Highest | Lowest | Standard |
|---|---|---|---|---|
| — | temperature | temperature | temperature | deviation |
| Embodiment 1 | 32.5° C. | 33.6° C. | 27.8° C. | 2.9° C. |
| Comparative | 40.8° C. | 44.3° C. | 35.6° C. | 4.2° C. |
| example 1 | | | | |
| Comparative | 37.6° C. | 40.8° C. | 33.9° C. | 3.5° C. |
| example 2 | | | | |
| Comparative | 38.1° C. | 41.5° C. | 34.2° C. | 3.7° C. |
| example 3 | | | | |

According to Table 2, it may be seen that embodiment 1 including the deformable component can allow the temperature on each region of the outer surface of the heat dissipation structure to be lower than 40° C. to meet market needs. In addition, embodiment 1 has a lower standard deviation of temperature data than comparative example 1 to comparative example 3, which means that embodiment 1 including the deformable component can provide a uniform cooling performance, and thus the temperature on the entire outer surface of the heat dissipation tends to be uniform.

In summary, according to the heat dissipation structure and the cooling method configured to cool the cable disclosed by the disclosure, the two-phase flow and the vortex are generated in the working fluid by the deformable component disposed in the fluid channel. The surface of the deformable component decreases the boiling point of the working fluid, and allows the two-phase flow to be formed more easily in the working fluid, thereby achieving the cooling purpose by the heat absorption during the vaporization. The deformable component in a helical shape allows the vortex to be generated in the working fluid to achieve the cooling purpose by including a plurality of turns. The temperature-adaptive characteristic of the deformable component can facilitate the formation of the two-phase flow and increase the strength of the vortex as the temperature of the working fluid is increased, thereby allowing the cooling efficiency of the working fluid to be dynamically increased as the temperature is increased.

In addition, it should be noted that the heat dissipation structure and the cooling method configured to cool the cable disclosed by the disclosure can be widely used in the electric vehicles and is not limited to the electric land vehicle. The heat dissipation structure and the cooling method configured to cool the cable disclosed by the disclosure may also be applied to, but not limited to, the thermal energy management of a refrigeration and air conditioning system or an energy storage cabinet.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A heat dissipation structure configured to cool cable and comprising:
a cable jacket, having a fluid channel extending along an axial direction of the cable jacket;
an electrical conductor, disposed in the cable jacket; and
a deformable component, being temperature-adaptive and in a helical shape, wherein the deformable component is disposed in the fluid channel, and the deformable component allows a two-phase flow and a vortex to be generated in a working fluid in the fluid channel.

2. The heat dissipation structure according to claim 1, wherein an axial direction of the deformable component is substantially parallel to an axial direction of the cable jacket.

3. The heat dissipation structure according to claim 1, wherein the deformable component and the cable jacket are coaxially disposed.

4. The heat dissipation structure according to claim 1, wherein the electrical conductor is in fluid communication with the fluid channel.

5. The heat dissipation structure according to claim 4, wherein the working fluid is non-conductive.

6. The heat dissipation structure according to claim 1, wherein the deformable component allows the two-phase flow to be generated in the working fluid in a temperature ranging from 40° C. to 90° C.

7. The heat dissipation structure according to claim 1, wherein the deformable component comprises a plurality of turns connected to each another, and the deformable component has an adaptive deformation characteristic so that the vortex is generated in the working fluid by changing an axial distance between two adjacent ones of the plurality of turns.

8. The heat dissipation structure according to claim 7, wherein the deformable component has the adaptive deformation characteristic so that the axial distance between two adjacent ones of the plurality of turns is varied in a range from 0.5 mm to 20.0 mm.

9. The heat dissipation structure according to claim 1, wherein the deformable component comprises a shape-memory alloy.

10. The heat dissipation structure according to claim 9, wherein the shape-memory alloy is selected from a group consisting of nickel-titanium alloy, manganese-silicon-iron alloy, zinc-copper-aluminum alloy, nickel-copper-aluminum alloy, nickel-titanium-iron alloy, and nickel-titanium-copper alloy.

11. A cooling method configured to cool cable, comprising:
providing a working fluid into a fluid channel of a cable jacket; and
allowing a two-phase flow and a vortex to be generated in the working fluid by a deformable component disposed in the fluid channel, wherein the deformable component is temperature-adaptive and in a helical shape.

12. The cooling method according to claim 11, wherein the two-phase flow and the vortex are simultaneously generated in the working fluid by the deformable component.

13. The cooling method according to claim 11, wherein the deformable component allows the two-phase flow to be generated in the working fluid in a temperature ranging from 40° C. to 90° C.

14. The cooling method according to claim 11, wherein the deformable component comprises a plurality of turns connected to each other, and the deformable component has an adaptive deformation characteristic so that the vortex is generated in the working fluid by changing an axial distance between two adjacent ones of the plurality of turns.

15. The cooling method according to claim 11, wherein the deformable component comprises a shape-memory alloy.

16. The cooling method according to claim 11, wherein the working fluid is non-conductive.
